(19) United States
(12) Patent Application Publication
(10) Pub. No.: US 2003/0162035 A1
(43) Pub. Date: Aug. 28, 2003

(54) Substrate with photocatalytic and /or hydrophilic coating

(76) Inventor: Xavier Talpaert, Paris (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/220,268

(22) PCT Filed: Mar. 7, 2001
(86) PCT No.: PCT/FR01/00679

(30) Foreign Application Priority Data
Mar. 8, 2000 (FR) 0002954

(51) Int. Cl. B05D 3/10; B32B 17/06

(52) U.S. Cl. 428/432; 427/337; 428/702

(57) ABSTRACT

The subject of the invention is a substrate (1) provided over at least part of its surface with a coating having photocatalytic and/or hydrophilic properties. The substrate is combined with a device (2) for distributing water over said coated surface.

The subject of the invention is also the method of implementing this combination.

The present invention relates to substrates provided with a photocatalytic coating and/or a hydrophilic coating, and their various applications.

It relates more particularly to photocatalytic coatings comprising semiconductor materials based on a metal oxide, especially a titanium oxide, which are capable, under the effect of radiation of suitable wavelength, of initiating radical reactions causing the oxidation of organic products. These coatings thus make it possible to confer novel functionalities on the materials that they cover, especially antifouling, fungicidal or bactericidal properties. At the same time, they generally have hydrophilic properties.

The invention also relates to coatings which are purely hydrophilic and which are photocatalytic in nature.

Whatever the coating, many substrates can be envisioned. It could especially involve material used in building construction, architectural material, such as walling, cladding, roofing, flat roofing or glazing materials. Mention may be made, in a nonlimiting manner, of the following materials: glass, metal, glass-ceramic, ceramic, cement, brick, wood etc. or any material reconstituted from these natural materials, organic polymers, especially transparent organic polymers such as polycarbonate.

Coatings containing crystallized anatase TiO₂ with photocatalytic properties are already known from International Patent Applications WO97/10186, WO97/10185 and WO99/44954, these coatings being obtained from the thermal decomposition of suitable organometallic precursors and/or from “precrystallized” TiO₂ particles embedded in a mineral or organic binder.

Layers with hydrophilic properties based on an at least partially oxidized silicon derivative, such as silicon oxide (stoichiometric or substoichiometric in oxygen), or silicon oxycarbide and/or oxynitride are also known from French Patent Application FR99/13937 of Nov. 5, 1999, equivalent to application PCT/FR00/03037 of Oct. 31, 2000. These layers may be deposited by means of the sol-gel method, by chemical vapor deposition or else by sputtering.

The aim of the invention is therefore to improve the efficiency of these various types of coating, especially so that their performance (photocatalytic and/or hydrophilic) is extended over time.

The subject of the invention is firstly a substrate provided over at least part of its surface with a coating having photocatalytic and/or hydrophilic properties, and which is associated with a device capable of distributing water over said coated surface.

In the context of the invention, the term “water” refers to any essentially aqueous solution that may contain a number of dissolved additives, of the surfactant or washing agent type.

The term “substrate” refers to all the materials mentioned above, especially those of the architectural type. More particularly, the invention focuses on the transparent substrates, used as glazing, to equip buildings, display screens, and street furniture. They are generally based on rigid substrates made of glass or of a polymer. They may also incorporate flexible substrates made of polymer, which are then joined to rigid substrates.

The photocatalytic coatings which are more particularly alluded to are those mentioned above, which comprise at least partially crystallized titanium oxide in anatase form. Furthermore, the coating may comprise another type of material generally in the form of at least one oxide, especially an amorphous or partially crystallized oxide. This may involve oxides of the silicon oxide, titanium oxide, tin oxide, zirconium oxide or aluminum oxide type.

The combination of a substrate functionalized in this way with a water distributor is quite unexpected, but provides a genuine improvement. This is because photocatalytic coatings can directly degrade fouling when it can be oxidized, that is to say when fouling is essentially organic in nature. Thus it may involve finger marks or oil residues. However, these coatings are not able to degrade mineral fouling. This mineral fouling tends to gradually cover the coating, and after a period of time, there is a risk of disactivating it in some way. It is even more so since these coatings often have a surface roughness intended to increase their active surface area. However, this relief is also favorable for clogging up by fouling which cannot be degraded by oxidation.

The invention therefore proposes to spray water at a given periodicity on the surface of these coatings for a double result:

on the one hand, the water is intended to carry away the mineral fouling, this carrying away being facilitated when the coating is hydrophilic. Part of the fouling is then removed from the glazing,

on the other hand, the water, by removing this mineral fouling from the coating, makes it more efficient in degrading the organic fouling (in the case of photocatalytic glazing).

This double effect contributes to obtaining glazing which, overall, is fouled less over time than photocatalytic/hydrophilic glazing which is not fitted with water distribution or than standard glazing. The “aggressive” manual cleanings using detergents can then be spaced out. This system enables insufficient pluviometry or a substrate arrangement not exposed to rain to be compensated for effectively. Thus, when the glazing is slightly set back from the wall of a building or in a not so favorable configuration, it is possible that it is never exposed to rain. The water distribution according to the invention thus makes it possible to recreate the effect of carrying away fouling by means of rain, but in a much more homogenous manner, without leaving streaks on the glazing, and without its random nature depending on the geographic location or the season in question.

Thus the invention is particularly useful in three scenarios (which may be cumulative):

when the glazing is exposed to particularly heavy/abundant mineral fouling. It may involve, for example, drips from concrete or aluminum, or sodium sulfate particles which are frequently encountered in a city atmosphere and which make the glazing blurred,

when the coatings are moderately photocatalytic/hydrophilic from the start (or by progressive clogging up especially by mineral fouling),

when there is little or no rain on the glazing, either because of climatic conditions or because of the configuration in which the glazing is fitted (for example when the glazing is mounted on a building wall flush with the inner wall, it rarely rains on the glazing, at least on its upper part).

Whether or not the mineral fouling is transparent, it decreases the photocatalytic/hydrophilic properties of the coating, by a sort of passivation or “screening”. The coating becomes less effective, cleaning is again needed, even if it less frequent than for glazing without a coating, which remains a problem when the glazing is difficult to access (especially roof glazing).

The focus of the invention therefore consists in enabling the frequency of “conventional” cleaning needed to keep the glazing clean to be decreased, compared to untreated glazing or glazing without water distribution.

By means of the water spray according to the invention, the effectiveness of the coating is restored and its ability to “autoclean” is improved by means of a simple measure, which makes it possible to exploit the hydrophilic nature of the coating, namely, according to the invention the water carries away the excess mineral fouling present on the surface of the coatings.

Two subsidiary advantages may be seen from the method according to the invention:

firstly, it makes it possible to space out the conventional cleanings, therefore to use less detergent, which is good for the environment,

secondly, the coatings are thus less stressed mechanically (less friction by means of cloths, scrapers, etc.) and therefore have less wear.

The invention is simple to implement. Thus, the water distribution may comprise a simple water spray rail capable of putting out either a series of discontinuous water streams, or a water sheet, in the direction of the coated surface of the substrate. The distributor may also comprise several spray rails. The simplest way is to exploit the effects of gravity, namely when the coated substrate, once mounted, is vertical or inclined, but not horizontal, it is enough for the water rail to distribute water in the direction of the top part of the coated surface, such that the water streams over its surface by means of gravity down to the bottom part.

When the substrate is glazing mounted outside, especially equipping a building wall, it is possible to place the water spray rail in or close to the casing of a roller shutter with which this glazing is equipped.

It is also possible to use spray rails or other spray systems placed on or close to the lateral uprights of the glazing (vertical if the glazing is in a vertical plane), the water may be sprayed, for example, by two rails opposite each other and spraying water toward the surface of the glazing in question.

It is also possible to combine with the substrate coated according to the invention a device capable of collecting the water once it has flowed over the substrate surface, for example a simple gutter.

There may be provision for the water distribution device, at the very least its terminal part of the spray rail type, to be secured to the substrate by mechanical means, and possibly together with the water collection device. It is preferable that these mechanical means allow the easy substitution of one rail by another should the water distributor be defective.

The distribution of water may be controlled in various ways: the control may be completely manual, by distributing the water as soon as the glazing appears to be slightly dirty. There is also the option of automatic distribution, which is triggered alone at set time intervals. Provision may also be made for a more sophisticated regulation, involving electronic or computing means, and taking into account, for example, the ambient pluviometry (for example using a moisture sensor) or the degree of fouling of the coating (optical modifications).

The regulation may also be carried out depending on the level of blurring of the glazing (its diffuse transmission in the visible region), by choosing the threshold beyond which the spray will automatically be triggered.

It is possible to control the frequency of water distribution, its duration and the water flow rate.

The water sprayed on the substrates according to the invention may be additive-free water, for example city water. The water distributor may then be fed using an ordinary water inlet, without having to store a particular liquid.

It is also possible to add one or more additives to the water: this may involve surfactants or degreasing agents, generally in small quantities. The substrates in question may then undergo not one spraying in one step, but a cycle with at least two sprayings one after another. In this way, it is possible to have a cycle with three steps: a spraying with additive-free water, a second spraying with water provided with additives then a third again with additive-free water acting as a rinsing step. It is also possible to have a cycle with only two steps, by removing the first step of the cycle mentioned above. This requires having as many spray rails as different liquids, or using a single spray rail where the automatic feed can be switched from one type of liquid to another (using storage reservoirs and/or water inlets).

The subject of the invention is also the method consisting in implementing this combination of a substrate functionalized by a photocatalytic and/or hydrophilic coating, with a water distributor for the purpose of reactivating said coating, in order to decrease the frequency of cleaning or to delay it being clogged up (the water distributor being capable of delivering additive-free water or at least for part of the water with suitable additives). The method according to the invention may thus use the water distributor described above, it may also use other means, not necessarily fixed, for distributing water, especially manually controlled means, such as a spray pipe, a sprayer or any other means containing suitable liquid.

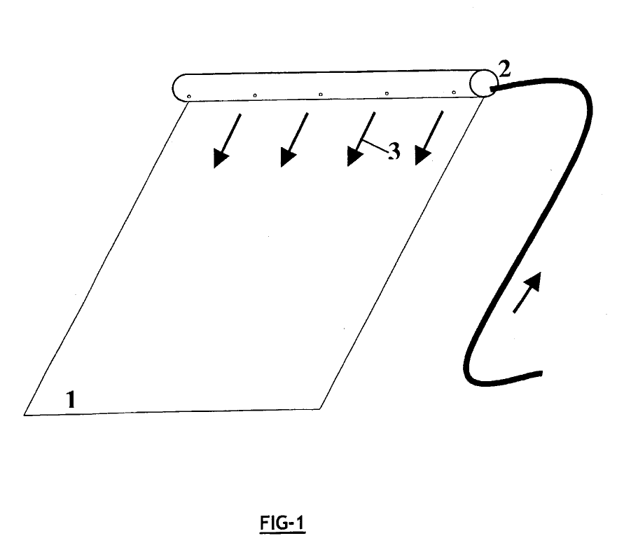

The invention will be described in more detail below with the help of nonlimiting examples, and FIG. 1 which shows in a very schematic manner a glazing unit in a position where it is mounted externally on a wall.

### EXAMPLE 1

This glazing unit 1 consists of 4 mm thick clear silica-soda-lime glass, provided with a thin 50 nm thick silicon oxycarbide (SiOC) layer, then a photocatalytic coating comprising crystallized anatase TiO₂ according to the teachings of aforementioned patent WO99/44954, more specifically close to its example 15. The deposition of the photocatalytic coating is carried out by sol-gel according to a spray-coating technique, from a dispersion mixing two initial solutions/dispersions 1 and 2:

solution 1: this is a solution containing the organometallic precursor of the mineral binder based on TiO₂ and SiO₂. This involves titanium tetrabutoxide stabilized with acetylacetonate CH₃CO—CH₂—CO—CH₃ and tetraethyl orthosilicate (TEOS), in solution in ethanol and ethylene glycol,

dispersion 2: this is the liquid phase in ethylene glycol containing the photocatalytic crystallized particles, with the following characteristics:

specific surface area of particles: 350 m²/g

particle size: 45 nm

size of cristallites forming particles: 7 nm

crystalline phase: more than 80% anatase

The composition of the dispersion from the mixture of solution 1 and dispersion 2 are adjusted to obtain the desired ratio:

r₁=TiO₂ (particles)/(TiO₂ binders),

that is to say the ratio of the weight of titanium oxide from particles of dispersion 2 to the weight of titanium oxide (1) and silicon oxide from solution 1. In this case, the ratio r₁ is about 50/50.

It is therefore a photocatalytic coating due to the presence of crystallized particles, which adhere to the substrate by means of the binder formed by the titanium oxide and the silicon oxide and which are overall amorphous and obtained by the thermal decomposition of the two titanium and silicon precursors.

### EXAMPLE 2

This example uses the same substrate as for example 1, provided with a first layer of 50 nm thick SiOC then a layer of photocatalaytic TiO₂ deposited by “cell-coating” from a solution containing titanium di-isopropoxydiacetylacetonate and titanium tetra-octyleneglycolate in solution in a mixture of ethyl acetate and isopropanol, according to example 9 of the aforementioned patent WO97/10186.

### EXAMPLE 3

This example still uses the same substrate, provided with a first 50 nm SiOC layer then a second photocatalaytic 60 nm TiO₂ layer obtained by means CVD from titanium tetraisopropylate, according to example 7 of the aforementioned patent WO97/10186.

The three glazing units functionalized in this way may be mounted on the building wall. Since they are then slightly set back, they are therefore not so exposed to the rain, even if there is any thereof. Therefore a water spray rail 2, itself also slightly set back from the wall so as to be almost invisible seen from the outside, is added to the upper part. It is connected to a water source by means of a suitable pipe (not shown). Automatically every week, the rail may distribute, for one to several minutes, water in the form of trickles 3 streaming down in a sheet from the top downward of the glazing units, in order to “regenerate” the photocatalytic coating and to remove mineral dusts therefrom. This removal of the dusts is further facilitated when the three photocatalytic coatings are all very hydrophilic.

In order to measure the beneficial effects of the invention on the effectiveness of the photocatalytic coatings, the three glazing units described above were installed, together with a fourth glazing unit free of any coating for the purpose of comparison, in an urban environment. The glazing units, 40×40 cm in size, were placed high up (50 meters) in order to have a “basic” (that is to say not disturbed by too close a proximity to the exhaust gases from motor vehicles) urban pollution environment, with mineral fouling mainly in the form of calcium sulfate particles. An awning made of borosilicate glass (transparent to UVA) was installed to protect the glazing units from rain.

It was observed that:

for the comparative glass without a photocatalytic coating, its diffuse transmission went from 0.2 to 5% of the total transmission in the visible in about two months,

for the three other glasses provided with the photocatalytic coating, the diffuse transmission also increased, however to a lesser a degree, and their photocatalytic activity dropped significantly at the end of a month (by about 25 to 30%).

A water rail consisting of a pipe drilled with holes spaced at 1 cm from each other and connected to a pump was then installed according to the present invention, under the awning. The rail sprayed the top of the glazing units for 1 minute once a week (flow rate: 1 liter/minute).

Under these conditions, it was observed that the diffuse transmission of the three glazing units provided with photocatalytic coatings remained less than 0.7% for at least two months. Their photocatalytic activity remained substantially the same at the end of one month. The comparative glass without a photocatalytic treatment had a diffuse transmission which reached 2% of the total transmission in the visible (T_{L}) at the end of 2 months. This therefore proves that spraying with water is enough for the most part to prevent the passivation of photocatalytic coatings and improves the antifouling effectiveness.

Many configurations are possible for the spray rail: it could be mounted (detachably) directly on the upright of the upper edge of the window (or on its lateral uprights). It may also be detachable on the wall itself or in or close to a roller shutter casing. It is preferable to choose the configuration which conceals it best, according to the mounting of the glazing unit, the building type, etc.

If the glazing unit is not vertical, and is slightly inclined with respect to the horizontal, it may be preferable for the water to be distributed at high pressure in order to have a real carrying away effect. Otherwise, a single low flow rate/low pressure stream falling just by gravity is ample: the invention is effective in amplifying or extending the antifouling effect of the photocatalytic and/or hydrophilic coatings without requiring complex apparatus, and without having to structurally alter said coatings, which is entirely advantageous. It makes it possible to significantly decrease the frequency of manual cleaning, and in parallel, the amount of detergent used in this cleaning.

The invention is applicable in the same way for glazing units provided with hydrophilic coatings which are not photocatalytic, in particular based on SiO₂, SiON or SiOC, of the type described in the aforementioned patent FR99/13937. More particularly, it involves coatings based on silicon oxide or oxycarbide with a refractive index able to vary between 1.45 and 1.80 (in particular 1.50 to 1.75 or 1.55 to 1.68) and with a thickness of at least 5 nm, in particular between 10 and 60 nm. Their contact angle with water is generally less than 35°, in particular less than or equal to 30°.

1. A substrate (1) provided over at least part of its surface with a coating having photocatalytic and/or hydrophilic properties, characterized in that it is combined with a device (2) for distributing the water over said coated surface.

2. A substrate (1) as claimed in claim 1, characterized in that it involves an architectural material of the walling, cladding, flat roofing, glazing type.

3. The substrate (1) as claimed in claim 1, characterized in that it involves a transparent substrate.

4. The substrate (1) as claimed in claim 1, characterized in that it is made of a glass, a ceramic, a glass-ceramic, a flexible or rigid organic polymer and is preferably transparent.

5. The substrate (1) as claimed in one of the preceding claims, characterized in that the coating is photocatalytic and comprises at least partially crystallized titanium oxide in the anatase form.

6. The substrate (1) as claimed in claim 5, characterized in that the coating also comprises another mineral, especially in the form of at least one oxide, in particular an amorphous or partially crystallized oxide and chosen from silicon oxide, titanium oxide, tin oxide, zirconium oxide and aluminum oxide.

7. The substrate (1) as claimed in one of claims 1 to 4, characterized in that the coating is hydrophilic and comprises an at least partially oxidized silicon derivative, chosen in particular from silicon oxide which is stoichiometric or substoichiometric in oxygen, silicon oxycarbide and/or silicon oxynitride.

8. The substrate (1) as claimed in one of the preceding claims, characterized in that the device (2) for distributing water comprises at least one spray rail capable of emitting discontinuous water streams (3) or a sheet of water in the direction of the coated surface of the substrate.

9. The substrate (1) as claimed in one of the preceding claims, characterized in that it involves a glazing unit provided on one of its outer faces with at least one photocatalytic and/or hydrophilic coating, which is arranged in a nonhorizontal plane and combined with a device for distributing water comprising a water spray rail (2) capable of emitting a curtain of water or discontinuous water streams in the direction of the top part of the coated face of the substrate, so that the water runs down over said face down to the bottom part.

10. The substrate (1) as claimed in claim 9, characterized in that the water spray rail (2) is placed in or close to the roller shutter casing of the glazing unit.

11. The substrate (1) as claimed in one of the preceding claims, characterized in that it is also combined with a device capable of collecting the water once it has flowed over the coated surface of said substrate, in particular in the form of a gutter.

12. The substrate (1) as claimed in one of the preceding claims, characterized in that the water distribution device, and possibly the water collection device, is secured to said substrate by mechanical means.

13. The substrate (1) as claimed in one of the preceding claims, characterized in that the distribution of water is automatically triggered periodically and/or is controlled manually and/or is regulated by electronic/computing means.

14. The substrate (1) as claimed in one of the preceding claims, characterized in that all or part of the distributed water contains additives of the surfactant or degreasing agent type.

15. The substrate (1) as claimed in claim 14, characterized in that the water distribution comprises at least two consecutive spray steps, in particular a step with water containing additives of the surfactant or degreasing agent type and a step with additive-free water.

16. A method of “reactivating” photocatalytic and/or hydrophilic coatings placed on the surface of substrates (1), especially transparent substrates of the glazing type, characterized in that the water is distributed periodically on the surface of said coatings.

17. The method as claimed in claim 16, characterized in that the water is distributed so as to cause a stream of water over the entire surface of the coating.

18. The method as claimed in claim 16 or claim 17, characterized in that the water is distributed by means of at least one water spray rail (2) which is capable of emitting discontinuous water streams (3) or a continuous curtain of water directed toward the coated surface, especially so that the water flows from the top downward of said surface located in a nonhorizontal plane.

19. The method as claimed in claim 18, characterized in that the water is distributed automatically, according to a given periodicity, and/or by manual control.

20. The method as claimed in one of claims 16 to 19, characterized in that the distribution of water is regulated, in particular its periodicity and its flow rate, by taking into account a number of parameters such as the level of fouling of the coating or the ambient pluviometry.

21. The method as claimed in one of claims 16 to 20, characterized in that the water is distributed according to spray cycles comprising at least two consecutive sprayings, in particular one step with the water containing additives of the surfactant or degreasing agent type and a step with additive free water.

22. The use of the substrate according to one of claims 1 to 15 in order to decrease the frequency of cleaning of said substrate and/or decreasing its clogging by mineral fouling.
